(19) United States
(12) Patent Application Publication
(10) Pub. No.: US 2024/0189827 A1
(43) Pub. Date: Jun. 13, 2024

(54) MODULAR SYSTEM FOR A GRAIN CRACKER AND A GRAIN CRACKING SYSTEM AND METHOD

(71) Applicant: Bunge SA, Geneva (CH)

(72) Inventors: Ramiro Saraiva da Silva, Florianópolis - SC (BR); Carlos Fernando Oliveira Cabeça Neves, Florianópolis - SC (BR); Sidney Roberto Dias de Carvalho, Florianópolis - SC (BR); Rafael Monteiro Veras, Florianópolis - SC (BR); Renan Bonnard, Florianópolis - SC (BR)

(73) Assignee: Bunge SA, Geneva (CH)

(21) Appl. No.: 18/278,557

(22) PCT Filed: Feb. 22, 2022
(86) PCT No.: PCT/BR2022/050055

§ 371 Date: Aug. 23, 2023

(30) Foreign Application Priority Data
Feb. 23, 2021 (BR) BR102021003370-3

(51) Int. Cl. B02C 4/38; B02C 4/06; B02C 4/42; B02C 25/00

(52) U.S. Cl. CPC B02C 4/38; B02C 4/06; B02C 4/42; B02C 25/00

(57) ABSTRACT

This invention refers to a modular system for a grain cracker, and a grain cracking system and method that generates cracked grains within a predetermined specification. The modular system comprises a motor (124); a PLC (134); and an external optimization unit (136) to drive the motor (124), based on an adjustment point (A). The grain cracking system (100) comprises: rollers (110); and a programmable logic controller, PLC (134), configured to: obtain an adjustment point (A), and control the gap between the rollers (110) from the obtained adjustment point (A). The grain cracking method comprises the steps of: obtaining (510) an adjustment point; controlling (520) the gap between the rollers; and altering (530) the adjustment point, should the characteristics of the cracked grains coming from the rollers not be compliant with the desired specifications, wherein the step of altering the adjustment point is performed continuously and automatically.

This invention refers to a modular system for a grain cracker, and a grain cracking system and method that generates cracked grains within a predetermined specification.

### BACKGROUND ART

Systems and methods for cracking grains, for example, soybeans, which are widely known and used at the prior art, also called grain cracking mills, involve cracking grains, obtaining the characteristics of the cracked grains, and adjusting the system according to the obtained characteristics. The adjustment is performed to ensure that the cracked grains resulting from the cracking process are components with the desired specifications and maximize oil extraction from the grains. The most commonly used grain cracking systems and methods constituting the prior art obtain the characteristics and adjust the system in a non-automated manner, using an operator, for example.

The grain cracking systems developed by the grain processing industry are generally comprised of devices that require the constant presence of operators, who are in charge of the operations and measurement of the output. After the measurement, the operator then decides whether or not the product obtained complies with the desired specifications for that specific product. If non-compliant, a manual adjustment of the devices necessary, in order to adapt the subsequent products to the desired specifications.

Furthermore, several cracking methods and operating methods for known systems are described at the prior art. Most of the methods also require the participation of an operator for adjusting the process and adapting the resulting product. This need leads to dependence on a skilled worker who is trained and qualified to handle this job.

As a result of the above-mentioned needs, the presence of human errors may be noted in systems and methods constituting the prior art, associated with the need for input from a skilled worker. For example, mention may be made of inaccurate adjustments of the devices, the limited frequency of adjustments, related to the high cost of each adjustment, fraud, etc. These errors affect the quality of the resulting product, as well as the efficiency of the cracking process.

An example of a device for cracking grains at the prior art is described in document U.S. Pat. No. 5,154,364. This document describes a technique configured to crack food seeds, such as soybeans, wheat, corn, etc. This technique allows the gap between the rollers to be adjusted, protecting the equipment and adapting the device to the task to be performed. This adjustment is handled by a motor and a sensor that measures the gap between the rollers. Grains that require more cracking into particles need a smaller gap between the rollers, while grains that require less cracking into particles need a wider gap between the rollers.

However, the described equipment requires information inputted by an operator to define the correct gap between the rollers. There is no automatic adaptation of the equipment based on the generated product. The operator must tell the equipment which operations are to be performed. There are also descriptions of external means that could provide real-time information on the products obtained, so that the device could adjust the gap between the rollers continuously and automatically. Furthermore, no means are described for ensuring reliable sensor readings.

Another example at the prior art is the technical layout of a seed cracking mill described in document MU 8400134-8. A description is given of using hydraulically-adjustable cylinders through a PLC. There is also a description of the variation in the speed differential between the cylinders, for enhanced efficiency.

In this case, mention is made of automatic cylinder adjustment through a hydraulic system commanded by a PLC. However, no adjustments are described or suggested for addressing the non-conformity of the end product with the desired specifications. Through the provided description, an operator is still required in order to measure the end product parameters and perform the adjustment of the cracking mill, which is operated automatically by the PLC. The PLC receives input only from moisture content sensors.

Looking at the teachings at the prior art, the known processes and devices do not describe a system or a method able to handle a grain cracking stage and continuously and automatically adjust the gap between the rollers based on the results obtained, such as, for example, the characteristics of the cracked grains.

Documents constituting the prior art also make no mention of the use of encoders and electric power drives to control the movement of the motors that control variations in the gap between the rollers.

Documents constituting the prior art also do not describe a modular system for installation and/or application on existing cracker models that function manually, for example.

### Purposes of the Invention

In view of the problems described at the prior art, the purpose of this invention is to provide a system and a grain cracking method that can adjust the characteristics of the end product, based on the characteristics obtained in products processed previously. The adjustment is handled through variations in the gap between the rollers that crack the grains continuously and automatically, no need for any input from operators.

The purpose of this invention is also to provide a system and a grain cracking method that can alter the gap between the rollers by individually moving at least one roller in each pair of rollers of the machine.

Another purpose addressed by this invention is to provide a grain cracking system and method that can correct errors between the measurements of the gaps between the rollers and the adjustment points defined by an external optimization unit.

Furthermore, the purpose of this invention is to provide a system and a grain cracking method that can alter the adjustment points through the motor current, should a predefined current limit be exceeded, resulting in greater security for the system.

Furthermore, another purpose of this invention is to provide a system and a grain cracking method that can handle adjustments the gap between the rollers more frequently than other known systems and methods, resulting in a more responsive system and method.

Another purpose of this invention is to adjust the gap between the rollers continuously and automatically during the grain cracking process, resulting in a cracking stage that is more efficient, accurate, and homogenous.

A purpose of an embodiment of this invention is to supply a modular system applicable to existing grain crackers.

### BRIEF DESCRIPTION OF THE INVENTION

This invention relates to a modular system for a grain cracker that comprises: a motor; a PLC connected to the motor; and an external optimization unit connected to the PLC, wherein the external optimization unit is configured to define an adjustment point, based on the characteristics of the grains to be cracked, wherein the PLC is configured to receive the adjustment point from the external optimization unit and drive the motor.

The modular system may be associated with an existing manual cracker model through connecting the axle of the motor to the axle of a screw. The connection between the axle of the motor and the screw axle may be performed by a mechanical reduction gearbox.

The characteristics of the grains to be cracked may include, for example, the moisture content and temperature of the grains to be cracked.

This invention also addresses a grain cracking system that comprises rollers and a programmable logic controller (PLC). The PLC is configured to obtain an adjustment point, and control the gap between the rollers from the obtained adjustment point. The adjustment point is defined according to the characteristics of the cracked grains coming from the rollers. The gap between the rollers is controlled continuously and automatically. Furthermore, the adjustment point is altered according to the values measured by sensors for the roller rotation motor current, vibration and temperature, the motor current, the hopper feed speed, the gap between the rollers, the characteristics of the grains to be cracked, and the characteristics of the cracked grains.

In one embodiment, the rollers in the grain cracking system may be at least one movable roller and one fixed roller. In another embodiment, the rollers are a plurality of pairs of rollers, wherein the gap between the rollers is controlled individually for each pair of rollers in the plurality of pairs of rollers.

Furthermore, the gap between the rollers is controlled by a roller drive system that comprises a motor and a screw, wherein the motor is coupled to the screw and the screw is coupled to a longitudinal extremity of the movable roller. The screw allows a linear horizontal movement of the movable roller.

The PLC of the grain cracking system also receives information on the position of the screw, based on a sensor, and compares the information on the position of the screw with the adjustment point, in order to define the activation of the motor and control the gap between the rollers.

The adjustment point comes from an external optimization unit, wherein the external optimization unit is configured to define the adjustment point, based on the characteristics of the cracked grains.

This invention also addresses a method for cracking grains that comprises the steps of: obtaining an adjustment point; controlling the gap between the rollers, wherein the gap between the rollers is defined from the obtained adjustment point; and altering the adjustment point, should the characteristics of the cracked grains coming from the rollers not be compliant with the desired specifications, wherein the step of altering the adjustment point is performed continuously and automatically.

In the grain cracking method addressed by this invention, the adjustment point is defined by an external optimization unit. Furthermore, the step of controlling the gap between the rollers is performed by a PLC through a roller drive system.

### BRIEF DESCRIPTION OF THE DRAWINGS

This invention will be described in greater detail below, based on an example of its embodiment, shown in the drawings. The Figures display:

FIG. 1—is a side view of an embodiment of the grain cracking system addressed by this invention;

FIG. 2—is a conceptual diagram of an embodiment of the grain cracking system addressed by this invention; and

FIG. 3—is a sequence of steps for an embodiment of the grain cracking method addressed by this invention.

### DETAILED DESCRIPTION OF THE DRAWINGS

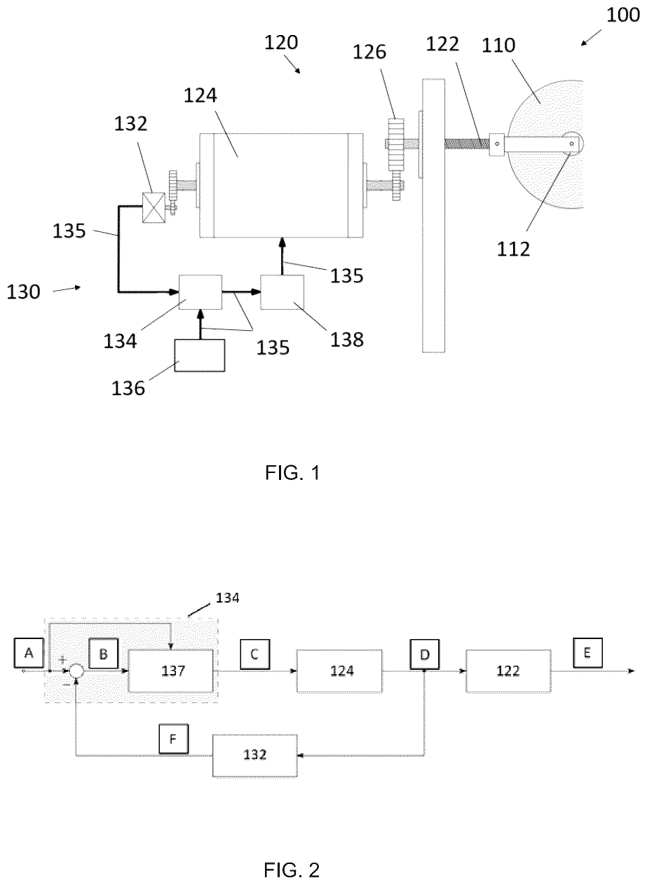

FIG. 1 shows a side view of the grain cracking system 100 according to an embodiment of this invention. In this example of an embodiment, the grain cracking system 100 comprises rollers 110, a roller drive system 120, and a control system 130.

In this embodiment, the rollers 110 in the grain cracking system 100 are cylinders coupled to bearings 112, that allow the rotation of the rollers 110 along their longitudinal axes. The rotation of the rollers 110 is powered by roller rotation motors (not shown). The bearings 112 define the position of the extremities of the longitudinal axles of the rollers 110 and may be coupled to screws 122. The bearings 112 not coupled to the screws 122 are fixed. The bearings 112 coupled to the screws 122 are movable in a direction transversal to the longitudinal axis of the roller 110. This freedom of movement of the bearings 112 allows the rollers 110 to move in a direction that is transversal to their longitudinal axes.

In one embodiment, the transversal freedom of movement of the rollers 110 is limited by the screw 122 to a transversal movement on a horizontal plane. At least one fixed roller 110, coupled to the fixed bearings 112, and one movable roller 110, coupled to the movable bearings 112, meet on this horizontal plane, thus forming a pair of rollers 110. The grain cracking system 100 described in this embodiment can thus move the movable rollers 110 closer to and further away from the fixed rollers 110, as required by the system.

In one embodiment, the grain cracking system 100 may comprise a plurality of pairs of rollers 110 in a plurality of horizontal planes. In this case, the gap between the rollers 110 is controlled individually for each pair of rollers 110 in the plurality of pairs of rollers 110. Using a plurality of pairs of rollers 110 in different horizontal planes and with different gaps between the rollers 110 allows the grains to run through different cracking processes before becoming the end product. The sequential cracking processes result in a better quality end product that is more homogenous.

One example of an embodiment is a grain cracking system 100 with two pairs of rollers 110 in two different horizontal planes. The pairs of rollers 110 are positioned in a manner that is substantially aligned vertically, whereby the product resulting from a cracking stage becomes the feedstock for the subsequent cracking stage. Although this example of an embodiment has been described, other configurations are also possible, such as, for example, a plurality of rollers 110, either movable and/or fixed, on the same horizontal plane, or a longer sequence of horizontal planes comprising pairs of rollers 110 that are substantially vertically aligned.

During the operation of the grain cracking system 100, the to and fro movement of the rollers 110 is reflected in a variation in the characteristics of the end product, in other words, of the cracked grain. The characteristics of the cracked grain define the quality of this product. It is thus crucial that the to and fro movement of the rollers 110 occurs in a precise and frequent manner. By employing adjustments to the position of the rollers 110, the grain cracking system 100 addressed by this invention allows the characteristics of the cracked grains, and consequently the quality, to be adjusted, compliant with the desired specifications.

The movement of the rollers 110 is powered by the roller drive system 120. In one embodiment, the roller drive system 120 comprises, in addition to the above-mentioned screws 122, the motors 124 are connected to the screws 122. As already mentioned, the screws 122 are coupled to the bearings 112 of the movable roller 110 and allow a linear movement of the roller 110 in a direction transversal to its longitudinal axis. Each movable roller 110 comprises two screws 122 whereby both extremities of the longitudinal axle can move simultaneously. This ensures the alignment of the movable roller 110 with the fixed roller 110 during the movement of the movable roller 110.

In one embodiment, the screw 122 is mechanically connected to the motor 124, which powers the movement of the screw 122. By turning the screw 122 on its longitudinal axis, the motor 124 moves the roller 110 bearing 112 in the longitudinal direction of the screw 122 and the transversal direction of the roller 110. The motor 124 may be, for example, an electric motor or, more specifically, a step motor. Using a step motor 124 allows accurate positioning of the movable roller 110 in terms of the fixed roller 110. However, other motors, such as a servomotor, may also be used, or other types of drives that allow this accurate adjustment of the roller 110.

In one embodiment, the motor 124 may be connected to the screw 122 by a mechanical reduction gearbox 126. The mechanical reduction gearbox 126 is configured to adjust the torque and angular speed of the screw 122 in relation to the motor 124, for the required specifications. However, the connection of the motor 124 to the screw 122 is not limited to the use of a mechanical reduction gearbox 126, and may be handled in different ways, with the adaptation of the torque and the angular speed.

In one embodiment, each screw 122 is driven by a motor 124. Consequently, each movable roller 110 is driven by two motors 124, as each extremity of the longitudinal axle of the movable roller 110 is coupled to a screw 122. In one embodiment with two pairs of rollers 110 in different horizontal planes, the grain cracking system 100 comprises two movable rollers 110 and two fixed rollers 110 and consequently four motors 124 in all. Other configurations to the sets of rollers 110 and roller drive systems 120 are possible, such as using one motor 124 to drive multiple screws 122, for example.

The roller drive system 120 is controlled by a control system 130. In one embodiment, the control system 130 comprises sensors 132, a programmable logic controller (PLC) 134, an external optimization unit 136 and a motor drive 138.

The sensors 132 are used to avoid measurement errors for the gap between the rollers 110, arising from possible slipping of the motor 124. In one embodiment, the sensor 132 monitors the horizontal position of the roller 110 through the angular variation of the motor rotor 124 or the axle of the screw 122. The sensor 132 may, for example, be connected directly to the motor rotor 124 to perform this monitoring. It is thus possible to enhance the reliability of the measurements of the gap between the rollers 110 after an initial referencing operation conducted during the installation of the grain cracking system 100.

An example of a sensor 132 used to monitor the gap between the rollers 110 is an absolute encoder that can convert shifts, such as the rotation of the motor rotor 124 into electrical pulses, for example. These electrical pulses are sent to the PLC 134 to help control the roller drive system 120.

The PLC 134 is a machine configured to receive signals from the elements of the grain cracking system 100, perform a computer routine, and control elements, based on the signals received and processed. In one embodiment, the PLC 134 is connected to the sensors 132, the external optimizing unit 136 and the motor drive 138. These connections 135 are connections that allow signals to be transmitted among the above-mentioned elements, with these signal transmissions able to take place through physical or remote connections 135, not being limited to any specific signal transmission type.

In one embodiment, the PLC 134 is connected to the motor drives 138, which are in turn connected to the motors 124, which turn the screws 122. The motor drive 138 is configured to receive signals from the PLC 134 and perform the switching of the power components in order to provide the current needed to drive the motors 124. In other words, the motor drive 138 forms a bridge between the PLC 134 and the motor 124.

FIG. 2 presents a conceptual diagram of the grain cracking system according to an embodiment of this invention. This embodiment shown in FIG. 2 presents a conceptual diagram of the embodiment shown in FIG. 1 for each side of each one of the movable rollers 110. The control loops for both sides of the rollers 110 have identical logics. However, the input parameters may be different, depending on the analysis generated by the external optimization unit 136, according to the values measured by sensors for the roller rotation motor current, vibration, and temperature in the mechanical parts of the grain cracking system 100, the motor 124 current the feed hopper speed, the gap between the rollers 110, the characteristics of the grains to be cracked, such as, for example, the moisture content and temperature of the grains, and the characteristics of the cracked grains, such as, for example, particle size. The characteristics of the grains to be cracked are the characteristics of the grains before running through the rollers in the grain cracking system 100 and the characteristics of the cracked grains are the characteristics of the grains after running through the rollers in the grain cracking system 100. The particle size of the cracked grains may be estimated from the above-mentioned values and with no need for it to be measured and entered into the external optimization unit 136.

In the configuration shown in FIG. 2, a gap E between the rollers 110 is provided by the screw 122. Each control algorithm generates a suitable and appropriate control signal C required by the motor 124 so that the gap E between the rollers 110 is attained. This value is proportional to an error B between an adjustment point A generated by the external optimization unit 136 and a gap F between the rollers 110, estimated by the sensor 132 and based on the number revolutions D of the screw 122.

The external optimization unit A feed speed, the gap between the rollers, the characteristics of the grains to be cracked, such as, for example, the moisture content and temperature of the grains and the characteristics of the cracked grains, such as, for example, particle size, and, consequently, to generate adjustment points A to the rollers 110 corresponding to what is being monitored in real-time. These generated adjustment points A are sent to a position controller 137 in the PLC 134 and analyzed according to the errors B to generate the control signal C. The external optimization unit 136 can estimate the particle size of the cracked grain based on the data mentioned above and suggest adjustment points A to correct the particle size, should it be off-spec

The mathematical models used may be based on logics defined by artificial intelligence, which extends beyond the scope of this invention. These models may be based on artificial intelligence trained through a dataset that correlates data on the roller rotation motor current, vibration, and temperature in the mechanical parts of the grain cracking system 100, the motor 124 current, the hopper feed speed, the moisture content, and the temperature of the whole grain to be cracked, the gap between the rollers 110, and the particle size of the cracked grain. Mathematical models and value correlations performed in a simpler manner may also be used.

For example, at a specific moment, if the sensors for the roller rotation motor current, vibration and temperature, the motor 124 current, the hopper feed speed, the gap between the rollers 110, the characteristics of the grains to be cracked, and the characteristics of the cracked grains are presenting specific values, the external optimization unit 136, will define adjustment points A that are ideal for the current process behavior, through the mathematical models, thus ensuring grain cracking quality that is compliant with the requirements established through the operation of the system.

In an example of an application, the moisture content of the grain to be cracked may increase during a certain period of time. In this case, the roller rotation motor current will increase, and may reach a level outside the normal operating range, and the particle size will deviate from the desired standard. Consequently, the model estimates the particle size of the cracked grain and suggests a new adjustment point A that is sufficient to separate the rollers 110, whereby the roller rotation motor current is brought back to normal, and the cracked grain is again compliant with the desired specifications. Based on the characteristics of the embodiment examples as described, the cracked grains system controls the gap between the rollers 110 continuously and automatically, based on information from the external optimization unit 136 and the PLC 134. Thus, the grain cracking system 100 can handle more frequent adjustments, which results in a cracking stage that is more efficient, accurate, and homogenous.

In one embodiment, the system addressed by this invention is a modular system for the automation of an existing or new grain cracker. In this embodiment, the modular system addressed by this invention may be associated with or installed on existing grain cracker models that are not automated. Consequently, the modular system addressed by this invention may transform crackers with manually adjustable rollers driven by screws into crackers with the gap between the rollers adjusted continuously and automatically.

In this embodiment, the modular system for a grain cracker addressed by this invention comprises the roller drive system 120 and the control system 130. This embodiment does not include the rollers, screws, and bearings described above, as these elements are already included in an existing cracker that will receive the modular system addressed by this invention.

In this embodiment, the roller drive system 120 comprises the motor 124 and the mechanical reduction gearbox 126 already described for other embodiments addressed by this invention.

In order to ensure the modularity of the modular system addressed by this invention and its installation on existing crackers, the motor 124 and the mechanical reduction gearbox 126 are connected to the screws 122 already in place on the crackers. Consequently, the mechanical reduction gearbox 126 is coupled to, slotted into, or associated with the axle of the screw 122 and the axle of the motor 124, providing the adaptation of the torque and angular speed of the screw 122 in relation to the motor 124, for the required specifications.

Alternatively, the motor axle 124 may be directly coupled to, slotted into, or associated with the axle of the screw 122. Also alternatively, the adaptation of the torque and angular speed may be handled in ways analogous to the mechanical reduction gearbox 126

In this embodiment, the motor 124 is controlled by the control system 130. In this embodiment, the control system 130 comprising the modular system is the control system 130 already described for other embodiments. The control system 130 comprises the sensors 132, the PLC 134, the external optimization unit 136, and the motor drive 138, as already mentioned.

The components comprising the control system 130 described in this embodiment have already been described in detail above, for other embodiments, with their characteristics and functions being the same for the modular system addressed by this invention.

The external optimization unit 136 is one of the components of the modular system described in this embodiment where modularity is possible. To do so, data reports on the roller rotation motor current, vibration and temperature, the motor 124 current, the hopper feed speed, the gap between the rollers, the characteristics of the grains to be cracked, and the characteristics of the cracked grains may be adjusted, according to the needs of each cracker and the desired end product.

In one embodiment of the modular system, the mathematical models used are artificial intelligence models that can be trained to adapt to different grain crackers on which the modular system can be installed or applied.

An example of a non-limiting application of this invention is described below, for a situation striving to obtain a mesh 10 particle size for the cracked grain. The modular system is applied to a cracker model, where the moisture content and temperature of the whole grain that will be cracked are 9.5% and 48° C. respectively, the roller rotation motor current is at 39 A and 21 A, the feed hopper speed is at 50%, the gap between the rollers is at 1.80 mm (top pair) and 1.5 mm (bottom pair), and the vibration of the mechanical parts is at 0.005 mm/s. In this case, the external optimization unit 136 will estimate, based on the data mentioned above, a value of 92% for the mesh 10 particle size of the cracked grain as it leaves the cracker. As this particle size is within an acceptable range of between 90% and 100% of the desired value, there is no need for the external optimization unit 136 to generate a new adjustment point A.

Still according to this non-limiting example, if, due to some outside factor, the moisture content of the whole grain to be cracked increases to approximately 11% and its temperature drops to approximately 42° C., the roller rotation motor current, and the vibration of the mechanical parts will increase to approximately 43 A and 27 A, and 0.007 mm/s respectively, while the feed hopper speed and the gap between the rollers are unalterable. In this case, the external optimization unit 136 will estimate, based on the data mentioned above, a value of approximately 85% mesh 10 particle size of the cracked grain as it leaves the cracker. As this particle size is not within an acceptable range of between 90% and 100%, a new adjustment point A of approximately 1.6 mm (top pair) and 1.3 mm (bottom pair) will be generated by the external optimization unit 136, moving the rollers further apart, bringing the motor current back to normal, with the cracked grain once again compliant with the desired specifications.

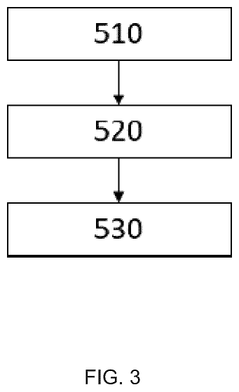

FIG. 3 shows a grain cracking method according to an embodiment of this invention. In this embodiment, the sequence of steps begins with a step of obtaining 510, in the PLC, the adjustment point defined by the external optimization unit. The adjustment point is used by the PLC to define the gap between the rollers as required to ensure that the end product is compliant with the desired specifications.

Next comes a step of controlling 520 the gap between the rollers, wherein the gap between the rollers is defined from the obtained adjustment point from the external optimization unit. The step of controlling 520 the gap between the rollers is performed by the PLC through the roller drive system. By controlling 520 the gap between the rollers, the grain cracking method moves the movable roller closer to or away from fixed roller. This to and for movement of the rollers is reflected in a variation in the characteristics of the end product, in other words, of the cracked grain.

In order to produce cracked grains that are compliant with the desired specifications, a step of altering 530 the adjustment point is performed, if the characteristics of the cracked grains coming from the rollers are not compliant with the desired specifications. This step is performed continuously and automatically, so that adjustments can be performed more frequently, and the grain cracking method results in a cracking stage that is more efficient, accurate, and homogenous.

The characteristics of the cracked grains may be estimated according to data reports on the roller rotation motor current, vibration, and temperature in the mechanical parts of the grain cracking system, the motor current, the cracker hopper feed speed, the gap between the rollers, and the characteristics of grains to be cracked, such as, for example, the moisture content and temperature of the grains.

Having described some examples of embodiments, it must be understood that the scope of this invention encompasses other possible variations, being limited only by the content of the Claims appended hereto, with possible equivalents included therein.

1. A modular system for a grain cracker, comprising:
a motor;
a PLC connected to the motor; and
an external optimization unit connected to the PLC,
wherein the external optimization unit is configured to define an adjustment point, based on the characteristics of the grains to be cracked, wherein the characteristics of the grains to be cracked include a moisture content and a temperature of the grains to be cracked, wherein the PLC is configured to receive the adjustment point from the external optimization unit and drive the motor.

2. The modular system, according to claim 1, wherein the modular system is associated with an existing cracker by connecting an axle of the motor to a screw axle.

3. The modular system, according to claim 2, wherein the connection between the axle of the motor and the screw axle is performed through a mechanical reduction gearbox.

4. A grain cracking system, comprising:
a plurality of pairs of rollers;
roller drive systems, wherein each roller drive system comprises a motor and a screw, wherein the motor is coupled to the screw and the screw is connected to a longitudinal extremity of one of the rollers; and
a programmable logic controller, (“PLC”), configured to:
obtain an adjustment point for each pair of rollers, and
control a gap between the rollers from the obtained adjustment points, wherein the gap between the rollers is controlled individually for each pair of rollers in the plurality of pairs of rollers by one of the roller drive systems, wherein each adjustment point is defined according to the characteristics of the cracked grains cracked by each pair of rollers, wherein the adjustment points are sent by an external optimization unit configured to define the adjustment points based on the characteristics of the cracked grains cracked by each pair of rollers, and wherein the gaps between the rollers are controlled continuously and automatically.

5. The grain cracking system, according to claim 4, wherein the adjustment point is altered according to values measured by sensors for the roller rotation motor current, vibration and temperature, a motor current, a hopper feed speed, a gap between the rollers, characteristics of grains to be cracked, and characteristics of cracked grains.

6. The grain cracking system, according to claim 4, wherein the pair of rollers comprises at least one movable roller and one fixed roller.

7. The grain cracking system, according to claim 4, wherein the screw allows a linear horizontal movement of the movable roller.

8. The grain cracking system, according to claim 4, wherein the PLC also receives information on the position of the screw, based on a sensor and compares the information on the position of the screw with the adjustment point in order to define the activation of the motor and control the gap between the rollers.

9. A method for cracking grains, comprising the steps of:
obtaining a plurality of adjustment points defined by an external optimization unit for a plurality of pairs of rollers;
controlling the gaps between the pairs of rollers through roller drive systems, wherein the gap between the rollers is controlled individually for each pair of rollers, wherein the gaps between the rollers are defined from the obtained adjustment points; and
altering the adjustment points of each pair of rollers, if the characteristics of the cracked grains coming from the rollers are not compliant with the desired specifications, wherein the step of altering the adjustment points is performed continuously and automatically.

10. (canceled)

11. (canceled)
